(19) United States
(12) Patent Application Publication
(10) Pub. No.: US 2014/0317268 A1
(43) Pub. Date: Oct. 23, 2014

(54) Automatic detection of optimal devices in a wireless personal network

(71) Applicants: Robbin Hughes, Plano, TX (US); Thomas O'Neill, La Jolla, CA (US); Prem Jothipragasam Kumar, San Diego, CA (US); Ramesh Rajasekaran, Chennai (IN)

(72) Inventors: Robbin Hughes, Plano, TX (US); Thomas O'Neill, La Jolla, CA (US); Prem Jothipragasam Kumar, San Diego, CA (US); Ramesh Rajasekaran, Chennai (IN)

(21) Appl. No.: 13/868,624

(22) Filed: Apr. 23, 2013

(51) Int. Cl. H04W 64/00

(52) U.S. Cl. CPC H04W 64/003
USPC 709/224

(57) ABSTRACT

The proposed embodiment provides a method and system for automatically detecting an optimal device over a network. The method includes receiving parameters associated with devices in the network, prioritizing the received parameters based on one or more rule, and detecting an optimized device based on the assigned priorities of the parameters associated with the devices.

### TECHNICAL FIELD

The embodiments herein relate to a wireless communications network and, more particularly, to a system and method for automatic detection of optimal devices in a wireless personal network.

### BACKGROUND

Generally, wireless personal network(s) allow users to share data among each other. The users can use their electronic devices from their respective locations such as home, office, and the like. Different device(s) present in the network may provide a myriad of services. For example, a home network may include a device to play music (e.g., a stereo), display videos (e.g., a television), print documents, store data (such as video or music), data transferring services, or the like. Providing optimal, energy-efficient detection and connection between these devices in the network involves significant challenges.

Different systems and methods are proposed to detect optimal devices in the network. The conventional systems and methods include a personal network consisting of several devices may be arranged in an ad-hoc fashion to dynamically communicate among each other. The appliances are either manually added using considerable user interaction, or semi-manually using a simple link revisit strategy. Further, mobility of the devices may include rapid changes in the network connectivity, availability, link quality, service capability, and bandwidth management. As devices constantly enter and leave the personal network, the determination of optimal devices for the user may need to be frequently evaluated and re-evaluated, which may require significant amount of system time and cost thereby decreasing the overall throughput and performance of the system.

Though the existing systems and methods are effective to a degree in detecting the optimal devices in the network, they include both advantages and disadvantages in terms of subjective understanding of each device in the network, device availability, optimization, characteristics, communication channels quality, false alarm, time, cost, user preferences, range, speed, bandwidth, workload, congestion, and the like.

### BRIEF DESCRIPTION OF THE FIGURES

The embodiments herein will be better understood from the following detailed description with reference to the drawings, in which:

FIG. 1 illustrates generally, among other things, a system 100 in which the present embodiment is embodied, according to embodiments disclosed herein;

FIG. 2 illustrates an example environment illustrating features of network controller as described in the FIG. 1, according to embodiments as disclosed herein;

FIG. 3 illustrates exemplary rules for prioritizing parameters of the devices, according to embodiments as disclosed herein;

FIG. 4 is a sequence diagram illustrating operations performed by the network controller as described in the FIG. 2, according to embodiments disclosed herein; and

FIG. 5 is a flow diagram illustrating a method for automatically detecting optimal devices in the network, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a system and method for automatically detecting an optimal device over a network. The system and method includes a network controller (or hub), configured to receive parameters associated with a plurality of devices in the network. The controller is configured to prioritize each received parameter, such as for detecting an optimal device within the network. The priority or appropriateness of each parameter associated with the device can be determined based on one or more rules, indicating the requirement or preferences of a user. Further, the controller combines the priorities of all the parameters associated with each device and detects the optimal device upon determining that a sum of all the priorities of the parameter associated with a device reaches a predefined priority threshold.

The proposed system and method is simple, reliable, and robust for detecting optimal devices in the network based on the user requirement and usage. The automatic nature of the present embodiment may improve the user experience and increase the system performance with significantly decreased time and cost. The system and method can be used optimizes the probability detection and probability of false alarm relative to battery power consumption throughout the personal network. The system can be used to lower the power and enhance the device availability and usage in the network by selecting optimal devices based on the plurality of rules including the user preferences and requirements. Such a rule-based system can be used to increase the system response time and provide effective services to the user. Further, the system and method can be used to provide seamless and uninterrupted service to the user by automatically switching among the devices. A complete optimal solution can be offered to the user by providing such seamless, optimal, and personalized devices to the user. Furthermore, the proposed system and method can be implemented on the existing infrastructure and may not require extensive set-up or instrumentation.

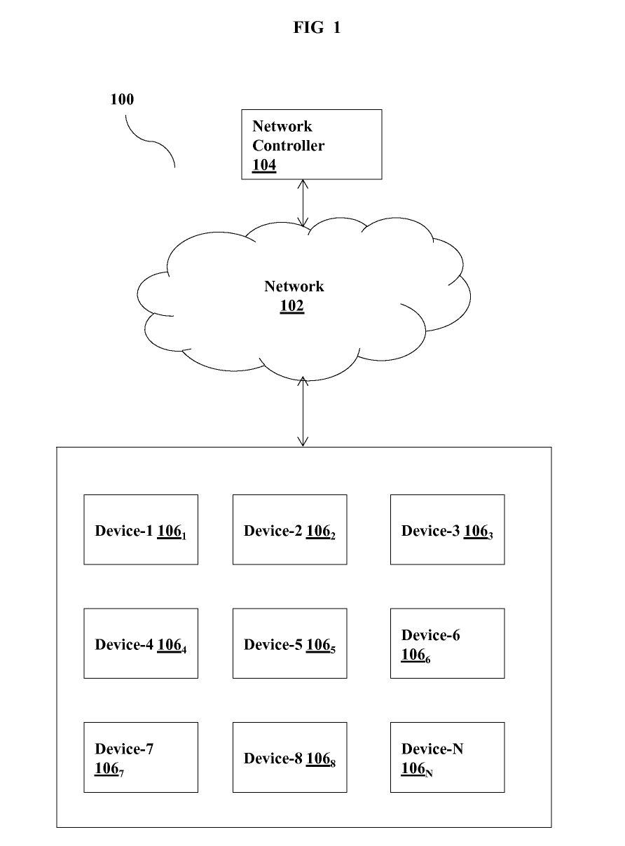

Referring now to the drawings, and more particularly to FIGS. 1 through 5, where similar reference characters denote corresponding features consistently throughout the figures, there are shown embodiments.

FIG. 1 illustrates generally, among other things, a system 100 in which the present embodiment is embodied, according to embodiments disclosed herein. The system 100 can include a network 102, a network controller 104, and one or more devices 106_{1-N} (hereafter referred as device(s) 106).

In an embodiment, the network 102 described herein can be for example, but not limited to, wireless network, wire line network, public network such as the Internet, private network, global system for mobile communication network (GSM) network, general packet radio network (GPRS), local area network (LAN), wide area network (WAN), metropolitan area network (MAN), cellular network, public switched telephone network (PSTN), personal area network, a combination thereof, or any other network.

In an embodiment, the controller 104 described herein can include for example, but not limited to, gateway device, router, hub, computer, laptop, wireless electronic device, personal digital assistance, smart phone, and the like. The controller 104 can be configured to include interfaces to connect with the devices 106 throughout the network 102. The controller 104 can be capable of coordinating the service requests and processing data to provide the requested (desired) services.

In an embodiment, the device(s) 104 described herein can include for example, but not limited to, gateway device, router, hub, computer, laptop, wireless electronic device, personal digital assistance, smart phone, and the like. Each device 106 can provide different advantages in terms of device availability, device characteristics, communication links/channel quality, user preferences, usage, range, speed, bandwidth, workload, congestion, security, power consumption, and the like.

The devices 106 can be configured to provide one or more services, such as to provide various functionalities and features to user(s). Each device 106 can include appropriate interfaces such to directly or indirectly communicate with the controller 104 and among each other over the network 102. Further, the devices 106 can be configured to include different, same, or substantially similar service(s) for the users. In an embodiment, the services described herein can include for example, but not limited to, web services, financial services, transaction services, social services, multimedia services, business services, economic services, technical services, religious services, data transfer services, printing services, ecommerce services, or any other type of services.

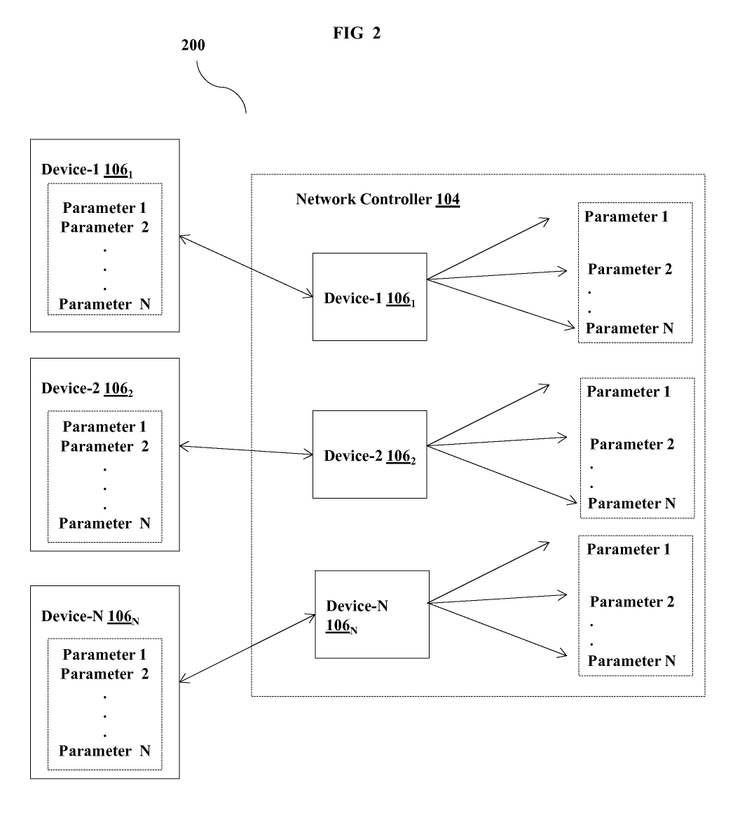

Further, the controller 104 can be configured to continuously monitor a plurality of parameters associated with each device 106 in the network 102. In an embodiment, the parameters described herein can include for example, but not limited to, device availability, device characteristics, services offered, communication link/channel, profile, user preferences, usage, range, speed, security, power consumption, bandwidth, workload, congestion, and any other parameter. Further, when a user requests a service, the system 100 can recommend one or more devices best suited and/or likely to adequately provide the requested service based on the parameters associated with the devices 106. The controller 104 can be configured to prioritize the parameters of each device 106 and provide appropriate, personalized, reliable, and optimized device to the user. The detailed description of the system 100 is described in conjunction with FIGS. 2-5.

In an embodiment, hardware portions corresponding to the system 100 may be included to provide the transmission and reception of signals among the devices 106, such as to provide the effective services to the user. Accordingly, the portions may include components (e.g., electronics) that perform functions, such as modulation, demodulation, amplification, and filtering. The various components in the network 102 may include for example, but are not limited to, servers, printers, speakers, mobile phones, any computational devices including among other things: a camcorder, a personal computer; a telephone, a personal communications system (PCS), facsimile, data communicators, personal music players (PMPs); personal digital assistants (PDAs), global positioning systems (GPSs), and any other components.

Although the FIG. 1 shows a set of devices 106 coupled to network 102, Further, the devices 106 may also be coupled with each other and may be able to communicate directly, indirectly, remotely, via third-party devices/network among each other. In other embodiments, system 100 may include more, fewer, or different components. Moreover, one or more devices associated with the network may perform one or more functions/operations of any other device.

FIG. 2 illustrates an example environment 200 illustrating features of the network controller 104 as described in the FIG. 1, according to embodiments as disclosed herein. As depicted in the FIG. 2, the environment 200 includes the network controller 104 communication with the plurality of devices 106 over the network 102. The controller 104 can be configured to continuously monitor and receive the parameters (1-N) associated with each service 106 throughout the network 102.

In an example, when a user of the personal area network accesses any device in the network 102, the system 100 can be configured to recommend one or more devices best suited or likely to adequately provide the requested service based on the parameters associated with the devices 106. The network controller 104 can be configured to detect the optimal and energy efficient device among the devices 106 in the personal network 102.

Each device in the personal network can be associated with a number of corresponding parameters (1-N) that can be tuned to affect the performance and responsiveness of the system 100, such as shown in the FIG. 2. In an example, the parameters described herein can include for example, but not limited to, device availability, device characteristics, services offered, near-by devices, communication link/channel, profile data, user preferences (such as historic data), usage, range, speed, bandwidth, workload, congestion, and the like.

Further, in an embodiment, the device characteristic parameter described herein can include for example, but not limited to, battery level, communication link/channel information (further including the channel quality derived from derived Signal-to-Noise Ratio (SNR)), different types of communications link used by the devices (for example, Bluetooth, ZigBee, Wi-Fi, P2P, ultra wideband, and the like), routing information, cost, device mobility, and the like. In an example, the profile parameter described herein can include for example, but not limited to, mode in which the device is running such as power saving mode, idle mode, sleep mode, and the like. The link quality information can include signal strength. The link quality information is used by the network controller 104 to decide whether a particular device in the wireless personal network has enough connectivity within the network to serve the request of the user.

Any changes in these parameters can affect the performance, sensitivity, cost, and reliability of the system 100. Further, the controller 104 can be configured to receive service(s) request from the user. In response to receiving the request the controller 104 can be configured to prioritize each received parameter associated with each device 106, based on one or more rules. In an embodiment, the controller 104 can be configure to execute the one or more rules on each parameter associated with the services, such as to prioritize the parameters based on the user needs and preferences.

In an embodiment, the one or more rules described herein can include elements indicating the user preferences and needs. In an example, the elements described herein can include for example, but not limited to, user historic activities, user interest, user frequent services, user service usage, user service cost plans, user device battery level, communication link/channel, profile, service quality requirement data, range, speed, bandwidth, security data, workload, congestion, or any other elements.

For example, if the user may request a printing service then network controller 104 can receive the parameters associated with the one or more devices 106 that provide printing service in the network 102. The parameters associated with the devices 106 may include for example, battery level of each device and link efficiency of each device. Further, the network controller 104 takes into account the battery power consumption and link efficiency parameters of the devices 106 for detecting the optimal and energy-efficient printing device among the devices that provides printing services in the network 102.

In an embodiment, the controller 104 can be configured to prioritize the parameters by assigning a value (on scale of 1 to 10) to each parameter based on the one or more predefined rules. For example, the battery power consumption and link efficiency of devices 106 are prioritized by the network controller 104 based on the one or more applicable rules. The rules include one or more elements indicating the user requirements and preferences. For example, if a device battery level is greater than 20% then the controller 104 is configured to assign a priority value 6 else 2. Similarly, if the a device battery level is less than 20% and the user history suggests the most recently used device is digital printer then the controller 104 is configured to assign a priority value 8 else 5. In an embodiment, the rules can be configured by either a network administrator or a user based on the requirements and needs.

Further, the controller 104 can be configured to combine the priorities of all the parameters associated with the devices offering the printing services. A sum of all the priorities of the parameters associated with each device can be calculated by the controller 104. Furthermore, the controller 104 can be configured to select the optimal device by comparing the sum to a predefined threshold. The predefined threshold described herein can be a decision matrix (such as value or threshold limits) for determining the optimal devices for providing the desired service to the user. In an embodiment, the priority threshold can be predefined by the network administrator or evaluated by the controller 104 based on the one or more rules. If the combined sum of priorities of all the parameters associated with any device offering the desired services reaches the predefined priority threshold then the controller 104 can be configured to detect that device as optimal device for offering the desired service and automatically switch to the selected device to provide the optimal service.

Further, the network controller 104 can be configured to constantly monitor the printing devices in the wireless personal network for detecting any change in their associated parameters. The constant monitoring of the device parameters can allow the controller 104 to provide seamless, optimal, personalized, reliable, uninterrupted, and enhanced services to the user.

In an embodiment, the network controller 104 can be configured to enter into sleep mode for certain time intervals, may be when it is running on low battery level, or when the idle time of the controller 104 passes a standard idle time period. The sleep time interval of the network controller 104 can be configured according to the requirements of the user or an administrator. Once the network controller 104 comes out of sleep mode, the process of monitoring of devices and prioritizing the parameters associated with the devices is continued for detecting the optimal devices in the network 02.

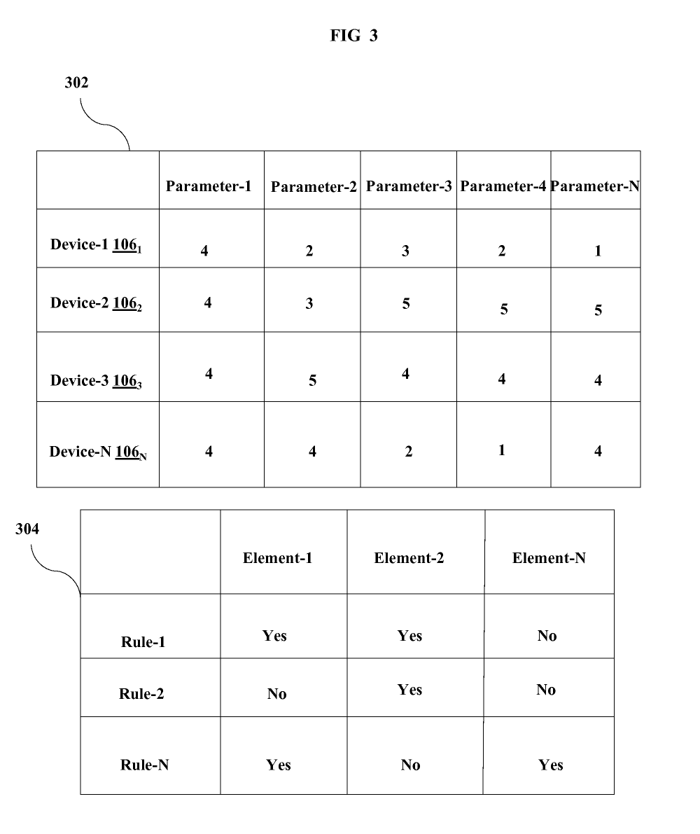

FIG. 3 illustrates exemplary rules for prioritizing the parameters of the devices 106, according to embodiments as disclosed herein. Each parameter of the device 106 can be received and prioritized by the network controller 104 based on the one or more pre-defined rules. As shown in the FIG. 3, an exemplary parameters and assigned priorities (on scale of 1 to 5) are described in table 302. Further, a set of predefined rules for prioritization of received parameters based on the battery level, device characteristics, and link quality information is described in table 304. As shown in the FIG. 3, the rule 1-N includes element-1, element-2, and element-N respectively. Each rule can include same (or substantially similar), and/or different set of elements.

These elements represent the requirements and needs of the user over the parameters (such as the device availability, device characteristics, communication links/channel quality, user preferences, usage, range, speed, bandwidth, workload, congestion, security, power consumption, and the like) of the devices 106. For example, the rule-1 states that if the battery level parameter of the device 106₁ is 60% and the element-1 of the rule indicates the desired need of the user is true (such as if the desired need of the user is to select a device which include greater than 50% of battery level) then the controller 104 is configured to provide a priority value of 4. Similarly, if the network controller 104 determines that all the other devices within the network 102 includes a battery level greater than 50% then a priority value as 4 can be assigned to the battery level parameter of all the other devices such as shown in the table 302.

Similarly, the network controller 104 obtains the communication link parameter associated with the devices 106. If the controller 104 determines that the user requirement is to use the Wi-Fi enabled devices then the controller 104 can assign a priority value as 5 to the devices which include Wi-Fi interfaces (such as the device 106₃). Similarly, the network controller 104 can determine the link quality parameter associated with the devices 106. If rule elements indicate that the user desired device should include a Signal-to-Noise Ratio (SNR) level greater than 10 then the controller 104 can assign a priority value as 5 to the devices whose SNR is greater than 10 (such as the device 106₂ as shown in the FIG. 3)

Further, the controller 104 can ensure that the parameters associated with devices are prioritized in order of appropriateness and requirements of the user based on the one or more rules. The controller 104 can be configured to include various combinations of elements, such as to provide priorities to each parameter of a device. Further, the various elements described herein include for example, such as user preferences, user history, network administrator preferences, device profile, controller profile, device battery level, controller battery level, device status (active/sleep/idle), controller status (active/sleep/idle), communication channels, and the like.

In an embodiment, the network controller 104 can be configured to combine the priorities of all the parameters associated with each device in the network 102, The controller 104 can calculate a sum of all the priorities of the parameters associated with each service of the device. For example, a sum of all the priorities of the parameters associated with device 106₁ may include, for example, 4+2+3+2+1=11. Similarly, for the device 106₂, a sum of all the priorities may include, for example, 4+3+5+5+5=22, and so on. Furthermore, the controller 104 can be configured to select the optimal device by comparing the sum to a predefined priority threshold. The predefined threshold can be a decision matrix (such as a value or threshold limits) for determining the optimal device for providing the desired service to the user. In an embodiment, the priority threshold can be predefined by network administrator or evaluated by the controller 104 based on the one or more rules. If the combined sum of priorities of all the parameters associated with a device reaches the priority threshold then the controller 104 can be configured to choose that device as optimal device for offering the desired service and automatically switch to the device to provide the optimal service. For example, if the priority threshold value as defined by the network controller 104 is 17 and the combined priorities (the sum value of all the priorities) associated with the devices 1-5 are 14, 15, 16, 13 and 17 respectively then the network controller 104 detects the device-5 (with the combined priority as 17) as the optimized device to provide the service, while rejecting the other devices.

Further, if the combined priorities of all the devices lie within the priority threshold value then the network controller 104 can select an optimal device whose combined priority value is closer to the priority threshold. Similarly, if the combined priorities of all the devices reaches (or greater than) the priority threshold value then the network controller 104 can select an optimal device whose combined priority value is greatest among all the devices.

Furthermore, the exemplary priorities and rules described herein are only for illustrative purpose and do not limit the scope of the embodiment. In real-time the priorities may be given using weighing factor, rank ordering methods, stars, ratings, and the like. Furthermore, the rules and prioritization can be implemented/performed in any order/form and other elements, components, steps, and operations, may be added, skipped, deleted, and modified without departing from the scope of the embodiment.

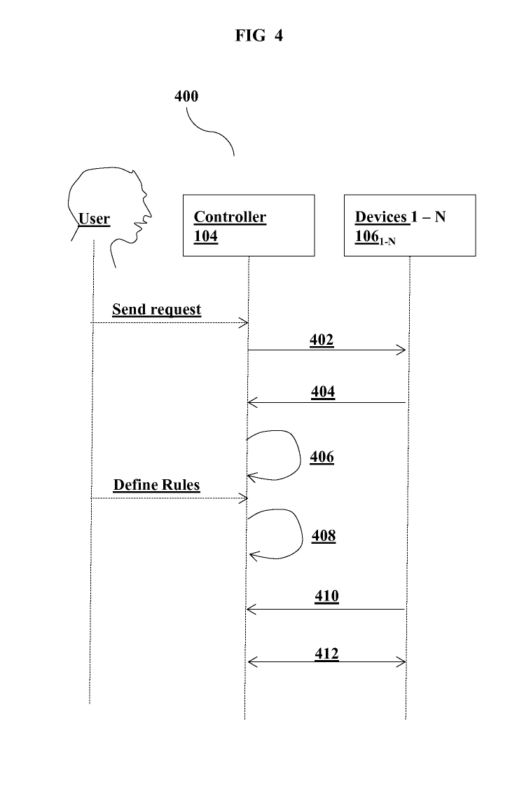

FIG. 4 is a sequence diagram illustrating operations 400 performed by the network controller 104 as described in the FIG. 2, according to embodiments disclosed herein. In an embodiment, at 402, the controller 104 can receive one or more request from a user to access the services offered by the device 106. In an example, the network controller 104 sends a request to obtain a plurality of parameters associated with the devices 106. The network controller 104 can send a query (requesting for the parameters) to all the devices (1 to N) in the network. In an embodiment, at 404, the controller 104 can receive the plurality of parameters associated with the device 106 over the network 102. In an example, the parameters described herein can include for example, but not limited to, device availability, device characteristics, services offered, communication link/channel, profile data, user preferences data, security, power consumption, usage, range, speed, bandwidth, workload, congestion, and any other parameter. Any changes in these parameters can affect the performance, sensitivity, cost, and reliability of the system 100.

In an embodiment at 406, the controller 104 can prioritize the parameters associated with the device 106 based on the one or more rules. In an example, the network controller 104 checks whether the user or administrator defined any rules for identifying the optimal devices in the network 102. In an example, the network controller 104 can allow the user to define one or more elements of the rules, such as to indicate the user desired needs and requirements. A customized web based interface may be provided to the user such as to customize the rules elements based on the user needs and requirements. For example, the user or the administrator can set the elements of the rules and define the priority threshold, which the network controller 104 can take into consideration while detecting the optimal device in the network. In an example, the controller 104 can prioritize the parameters by assigning a value (on scale of 1 to 10) to each parameter based on the one or more applicable rules. The rules described herein can include elements such as for example, but not limited to, user historic activities, user interest, user frequently used devices, user device usage, cost plans, user device battery level, communication link/channel, profile data, service quality requirement data, range, speed, bandwidth, workload, congestion, security, or any other elements indicating the user preferences and needs.

In an embodiment, at 408, the controller 104 can combine the assigned priorities (values) of all the parameters associated with each device 106. In an example, the controller 104 can calculate a sum of all the priorities (values) assigned to the parameters associated with each device in the network 102.

In an embodiment, at 410, the controller 104 can detect the optimal device by comparing the sum of all the priorities of parameters associated with each device to a predefined threshold. The predefined threshold described herein can include a decision matrix (such as a value or threshold limits) to determine the optimal device for the providing the desired service to the user. The priority threshold can be predefined by a network administrator (or by any other user) or evaluated by the controller 104 based on the one or more rules. The controller 104 can select the optimal device for the user to provide the service upon determining that the combined priority (or the calculated sum of all the priorities) of the parameters associated with a device reaches the predefined priority threshold.

In an embodiment, at 412, the controller 104 can constantly monitor the parameters associated with the device 106 to automatically manage and switch among the devices offering the desired service. The constant monitoring of the service parameters can allow the controller 104 to provide seamless, optimal, personalized, reliable, uninterrupted, and enhanced services to the user.

The various operations, blocks, acts, or steps described with respect to the FIG. 4 can be performed in the order presented, simultaneously, parallel, a combination thereof, or in any other order. The operations, acts, or steps herein are only for illustrative purpose and do not limit the scope of the embodiment. Further, in some embodiments some of the operations, acts, or steps can be added, skipped, omitted, or modified without departing from the scope of the embodiment.

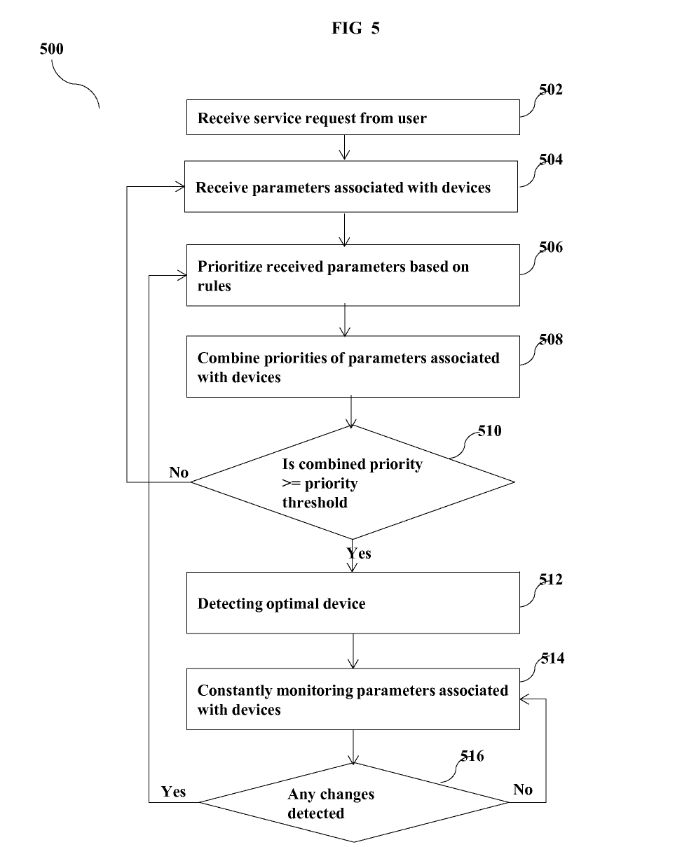

FIG. 5 illustrates a flow diagram illustrating a method 500 of automatically detecting optimal devices in the network 102, according to embodiments as disclosed herein. In an embodiment, at 502, the method 500 includes receiving a request from the user to access a service associated with the device 106. In an example, the method 500 allows the network controller 104 to receive the service request from the user. In an embodiment, at 504, the method 500 includes, receiving a plurality of parameters associated with the devices 106. In an example, the method 500 allows the network controller 104 to send request to the devices 106 to receive the parameters associated with the devices 106 throughout the network 102. Each device in the personal network can be associated with a number of corresponding parameters (1-N) that can be tuned to affect the performance and responsiveness of the controller 104. The parameters described herein can include for example, but not limited to, device availability, device characteristics, services offered, communication link/channel, profile data, communication links/channel, user preferences data, usage, security, range, speed, bandwidth, workload, congestion, power consumption data, and any other parameter.

In an embodiment at 506, the method 500 includes prioritizing the parameters associated with the device 106 based on the one or more rules. In an example, the method 500 allows the network controller 104 to prioritize the parameters by assigning a value (on scale of 1 to 10) to each parameter based on the one or more applicable rules. The rules described herein can include elements such as for example, but not limited to, user historic activities, user interest, user frequently used devices, user device usage, cost plans, user device battery level, communication link/channel, profile data, service quality requirement data, range, speed, bandwidth, workload, congestion, security, or any other elements indicating the user preferences and needs.

In an embodiment, at 508, the method 500 includes combining the assigned priorities (values) of all the parameters associated with each device 106. In an example, the method 500 allows the controller 104 to calculate a sum of all the priorities (values) assigned to the parameters associated with each device in the network 102.

In an embodiment, at 510, the method 500 includes determining whether the sum of all the priorities exceeds a priority threshold. In an example, the method 500 allows the network controller 104 to detect the optimal device by comparing the sum of all the priorities to the predefined threshold. The predefined threshold described herein can be a decision matrix including a value or threshold limits to determine the optimal device for the providing the desired service to the user. The priority threshold can be pre-defined by the network administrator or evaluated by the controller 104 based on the one or more rules.

In an embodiment, at 512, the method 500 includes detecting the optimal device upon determining that the sum of all the priorities of the parameters associated with the devices 106 reaches the predefined threshold. In an example, the method 500 allows the controller 104 to allocate the optimal device to the user upon determining that the sum of all the priorities of the parameters associated with a service reaches the predefined priority threshold.

In an embodiment, at 514, the method 500 includes constantly monitoring the parameters associated with the devices 106, such as to automatically manage and switch among the devices offering the desired service. The constant monitoring of the device parameters can allow the controller 104 to provide seamless, optimal, personalized, reliable, uninterrupted, and enhanced services to the user. In an embodiment, at 516, the method 500 includes determining any changes or any new devices entered the network. In an example, the method 500 allows the controller 104 to detect changes in the parameters of the device 106 or if any new device is added or deleted in the network 102. Any changes in the parameters can affect the performance, sensitivity, cost, and reliability of the controller 104. In an embodiment, upon detecting any changes in the parameters, the method 500 includes repeating the steps 506 through 516 such as to provide seamless and uninterrupted service to the user.

The various actions units, steps, blocks, and acts described in the method 500 may be performed in the order presented, in a different order, or simultaneously. Further, in some embodiments, some actions, units, steps, blocks, and acts listed in the FIG. 5 may be omitted, added, skipped, and modified without departing from the scope of the embodiment.

The embodiments disclosed herein can be implemented through at least one software program running on at least one hardware device and performing network management functions to control the network elements. The network elements shown in the FIGS. 1-5 include blocks which can be at least one of a hardware device, or a combination of hardware device and software module.

The embodiment disclosed herein specifies a system and method for automatically detecting an optimized device over a network. The mechanism allows optimum device selection based on the one or more rules embodied in the system thereof. The mechanism can automatically make decisions on appropriate revisit periods, parameters and detection thresholds to optimize detection probability relative to battery power consumed in the personal network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for automatically detecting an optimal device over a network, the method comprising:
receiving at least one parameter associated with at least one device in said network;
prioritizing said at least one parameter based on at least one rule; and
detecting at least one optimized device based on said priorities of said at least one parameter associated with said at least one device.

2. The method of claim 1, wherein said method further comprises:
combining said priorities of said at least parameter associated with said at least one device;
determining whether said combined priorities of said at least parameter associated with said at least one device reaches a predefined priority threshold; and
detecting said at least one optimized device upon determining that said combined priorities of said at least parameter associated with said at least one device reaches said predefined priority threshold.

3. The method of claim 1, wherein said at least one parameter associated with said at least one device comprises at least one of said device availability, said device characteristics, said device near-by devices, services offered by said device, communication channel, profile data, user preferences, usage data, range, speed, bandwidth, workload, security data, and congestion.

4. The method of claim 1, wherein said at least one rule comprises a plurality of elements associated with at least of said controller and said devices.

5. The method of claim 1, wherein said method further comprises communicating at least one request to receive said at least one parameter associated with said at least one device in said network.

6. The method of claim 1, wherein said method further comprises constantly monitoring said parameters associated with said at least one device in said network.

7. The method of claim 6, wherein said method further comprises switching among devices based on at least one of said monitoring and said rules.

8. A system for automatically detecting an optimal device over a network, the system comprising a controller configured to:
receive at least one parameter associated with at least one device in said network,
prioritize said at least one parameter based on at least one rule, and
detect at least one optimized device based on said priorities of said at least one parameter associated with said at least one device.

9. The system of claim 8, wherein said controller is further configured to:
combine said priorities of said at least one parameter associated with said at least one device,
determine whether said combined priorities of said at least one parameter associated with said at least one device reaches a predefined priority threshold, and
detect said at least one optimized device upon determining that said combined priorities of said at least one parameter associated with said at least one device reaches said predefined priority threshold.

10. The system of claim 8, wherein said at least one parameter associated with said at least one device comprises at least one of said device availability, said device characteristics, said device near-by devices, services offered by said device, communication channel, profile data, user preferences, usage data, range, speed, bandwidth, workload, security data, and congestion.

11. The system of claim 8, wherein said at least one rule comprises a plurality of elements associated with said at least one of said controller and said devices.

12. The system of claim 8, wherein said controller is further configured to communicate at least one request to receive said at least one parameter associated with said at least one device in said network.

13. The system of claim 1, wherein said controller is further configured to constantly monitor said at least one parameter associated with said at least one device in said network.

14. The system of claim 13, wherein said controller is further configured to switch among said devices based on at least one of said monitoring and said rules.
